(19) United States
(12) Patent Application Publication
(10) Pub. No.: US 2008/0109612 A1
(43) Pub. Date: May 8, 2008

(54) Dynamic Code Relocation for Low Endurance Memories

(76) Inventor: Kevin M. Jones, Cary, NC (US)

Correspondence Address: TEXAS INSTRUMENTS INCORPORATED, P O BOX 655474, M/S 3999, DALLAS, TX, 75265, US

(21) Appl. No.: 11/555,746

(22) Filed: Nov. 2, 2006

(51) Int. Cl. G06F 12/00

(52) U.S. Cl. 711/154; 711/E12.001

(57) ABSTRACT

This invention identifies two approaches for reducing stress on non-volatile memory cells subject to excessive read/write operations. The first approach involves modifying the operating system code to apply a deterministic process to identifying memory locations based on collected metrics and reprogramming the memory management unit. The second approach involves augmenting an existing memory management unit (MMU) with capability to automatically move physical addresses based on the number of accesses made to locations within a locality, memory page or memory block.

### TECHNICAL FIELD OF THE INVENTION

The technical field of this invention is effective use of low endurance memories.

### BACKGROUND OF THE INVENTION

To meet the ever-increasing demands for higher levels of system integration, the semiconductor industry has consistently considered a number of new technologies to increase device performance and reduce die size. High-density memory has been integrated into system-on-chip (SOC) designs and the demand for ever-larger memories has presented many new challenges.

Conventional CMOS memory structures have been found increasingly more difficult to fabricate as the geometric dimensions of the required devices has been reduced to tens of nanometers. Competing technologies have in some cases shown higher device yield and excellent operating speed performance. At small geometric size, however, additional factors, reliability and length of life before degradation are emerging as issues.

One of the promising new technologies is eFRAM, RAM fabricated using ferro-electric components, integrated with more conventional CMOS. eFRAM memory is non-volatile, but it has limited read/write cycle capability, or low endurance. The high densities achieved by eFRAM along with its cost and power consumption make it an ideal candidate for embedded applications e.g. a single chip cell phone or embedded processors.

eFRAM endurance limitations has often led to specified limits on the number of read/writes for any given cell of the memory device. Traditional methods for avoiding failures due to defective cells involve substitution of supplementary cells as excessive use of cell clusters results in failures. This technique can detract from system performance and the supplementary cells added to the design detract from the eFRAM density achievable. What is needed is an approach that will prevent the onset of failure in the eFRAM cells by taking corrective action before failures occur.

For illustrative purposes consider a typical embedded application (e.g. the digital baseband of a cellular modem). Assume that the embedded application contains one main processor, external flash and internal memory all of which is SRAM. FIG. 1 illustrates the core block diagram of a basic conventional digital baseband unit 100 employing a DSP 101, external Flash Memory 111 and an embedded memory array composed of SRAM units 107 through 110. Applications hardware is accessed via the application unit interface 105.

The memory management unit (MMU) 102 provides virtual to physical address mapping. It includes the hardware required to control the read and write operations via read/write buffers 106 and contains a programmable table that stores the virtual to physical address mapping. When a virtual memory location is addressed by the CPU the MMU will provide the physical address of the memory. The MMU address tables are capable of being updated during software execution. The boot ROM 104 launches the start of system use, typically copying some code from external flash 111 to internal memory and performs initial programming of the MMU. Code execution then takes places either within the internal memory or from the external flash. The operating system code 103 provides the foundation for application algorithms to execute. It contains a software interface for controlling and directing hardware resources while performing essential time keeping and control functions. These time keeping and control functions can generate excessive numbers of read/write cycles for certain areas of the memory.

The major areas of interest in current digital baseband design involve improved performance and decreased cost. Because memory consumes a large part of system size and cost it is the object of intense focus. Both lower cost and improved performance can be achieved through the use of technology supporting aggressive memory designs. One promising memory technology uses ferro-electric memory cells and is referred to as eFRAM. Steady improvement has resulted from years of development work on eFRAM with geometry of components reduced to the tens of nano-meters and excellent device yields. eFRAM cells have been observed to be subject to cell aging over periods of intense use, the manifestation being that the parametric separation between stored 1s and stored 0s decreases and becomes difficult to resolve with current sense amplifier techniques. FRAM cells are said to have low endurance and this limits their ability to replace traditional SRAM and Flash memory in current applications. For eFRAM to be used it is essential that the amount of memory accesses for the code/data that reside in eFRAM memory cells be controlled and limited.

### SUMMARY OF THE INVENTION

Some non-volatile memory technologies being considered for high density memory arrays have shown a tendency to degrade with intense access at a given location. This invention describes two approaches for reducing stress on these non-volatile memory cells subject to excessive read/write operations. The first approach involves applying a deterministic process imposed in the operating system code to identifying memory locations based on collected metrics and dynamically re-programming the MMU. The second approach involves augmenting an existing memory management unit (MMU) with capability to automatically move physical address contents based on the number of accesses made to locations within a locality, memory page or memory block. Additional logic to accumulate memory access metrics, move physical memory contents and to reprogram the virtual address table would be included in the MMU. In this second approach the MMU would have the ability to designate certain segments as relocatable, accept a threshold for limiting frequency of access, and update its MMU table.

### BRIEF DESCRIPTION OF THE DRAWINGS

These and other aspects of this invention are illustrated in the drawings, in which:

FIG. 1 illustrates the core block diagram of a basic conventional digital baseband unit employing a DSP, external flash and an embedded memory array (Prior Art);

FIG. 2 illustrates the core block diagram of a basic digital baseband unit employing a DSP and an embedded memory array with two SRAM units replaced by eFRAM and with modified operating system code;

FIG. 3 illustrates the flow diagram for the first embodiment of the invention, the method for preventing excessive memory accesses by having the operating system actively manage the location of highly used memory cells using a deterministic process;

FIG. 4 illustrates the core block diagram of a basic digital baseband unit employing a DSP and an embedded memory array with two SRAM units replaced by eFRAM and with modified memory management unit; and

FIG. 5 illustrates the flow diagram of the second embodiment of the invention, a method for dynamically relocating memory contents by augmenting the memory management unit so that it contains a programmable mechanism that triggers and executes the relocation process once a threshold has been met or exceeded. The augmented MMU now has additional logic to accumulate memory access metrics, move physical memory contents and to reprogram the MMU virtual address table.

### DETAILED DESCRIPTION OF PREFERRED EMBODIMENTS

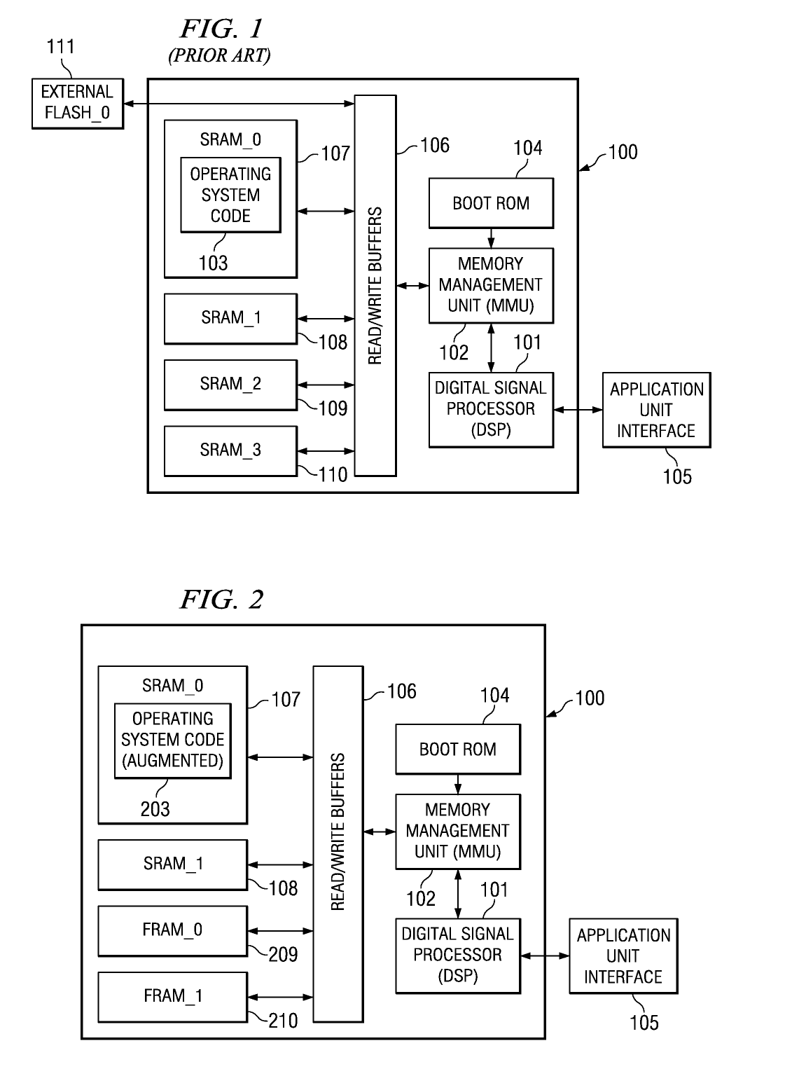

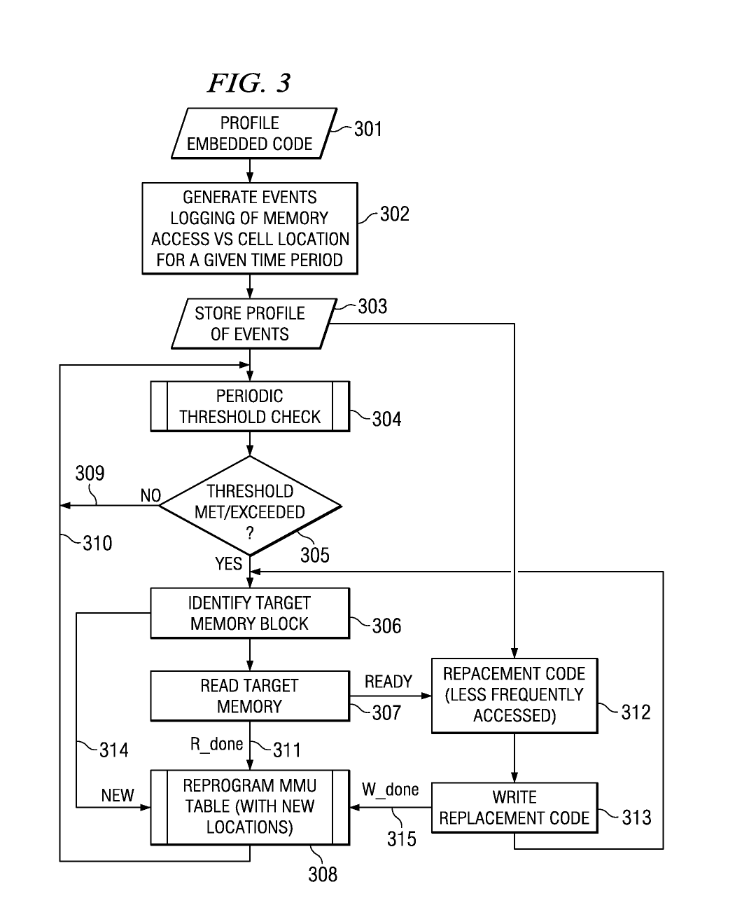

One method for preventing excessive memory accesses is to have the operating system actively manage the location of highly used memory cells using a deterministic process. FIGS. 2 and 3 illustrate the techniques of the first method. In FIG. 2 two eFRAM memory units 209 and 210 replace the SRAM units 109 and 110 shown in the conventional system of FIG. 1. Because the eFRAM memory units provide non-volatile memory for the system, the need for the external flash memory 111 of FIG. 1 is eliminated. The operating system code 203 is augmented with additional embedded code forming the basis for the deterministic process. This embedded code causes separate records to be generated for each process sequence.

The steps in the method are illustrated in the flow diagram of FIG. 3. The steps and signal paths are as follows:

Step 301: the embedded code is profiled setting up event tracking for each process.

Step 302: generate events data logging memory access vs. cell location within each memory block per a given time period for each process within the embedded system.

Step 303: store profile of events data. This is used to identify memory blocks that have excessive access characteristics and determine the threshold update amount for each time period.

Step 304: a periodic threshold check function is employed and profile information is forwarded for threshold check.

Step 305: the determination in query step whether any access threshold has been met or exceeded. Two outcomes are possible.

Outcome 1: If the access threshold for a block has been met as indicated by the Yes result then:

Step 306: the target memory block for replacement has been identified. The operating system program or system software will dynamically relocate this physical block of memory and update the MMU table. The corrective action called for is:

Step 307: make a copy of the memory block data to be relocated by a READ of the target memory block.

Path 311 signifies that the read R_done is complete and sends a ready signal allowing for replacement code to be selected in block 312.

Step 312: the replacement code is selected using profile information from block 303 activating step 313.

Step 313: a WRITE to the target memory block 306.

Finally the READ 307 and the WRITE 313 have been performed. The state of the R_Done signal 311, the W_Done signal 315 and the New signal 314 signify that step 308 may proceed.

Step 308: reprogram MMU table is activated to update the MMU tables with the newly-assigned memory locations.

Outcome 2: for each query completed in step 305 in which a No result indicates the threshold has not been met, then:

Path 309 activates the loop back to step 304 to perform the next periodic check of all vulnerable memory locations.

Similarly, upon reprogramming the memory management unit in step 308 triggered by a Yes result in query step 305, loop 310 is activated to perform the next periodic check 304. As a result the augmented operation system code acts to replace any effected code block with the contents of a less frequently accessed code block and reprograms the physical addresses in the MMU. The once heavily-used memory locality now has contents that are not heavily accessed. The once infrequently accessed physical memory block now contains more highly accessed contents. Since newly programmed MMU will now direct virtual address calls to the new physical address of the memory blocks, higher-level algorithms and code can then operate transparently without recognizing the corrective action and the relocated code would operate normally. By moving the physical location of the effected code the underlying memory cells can then be re-used by routines with less aggressive access profiles.

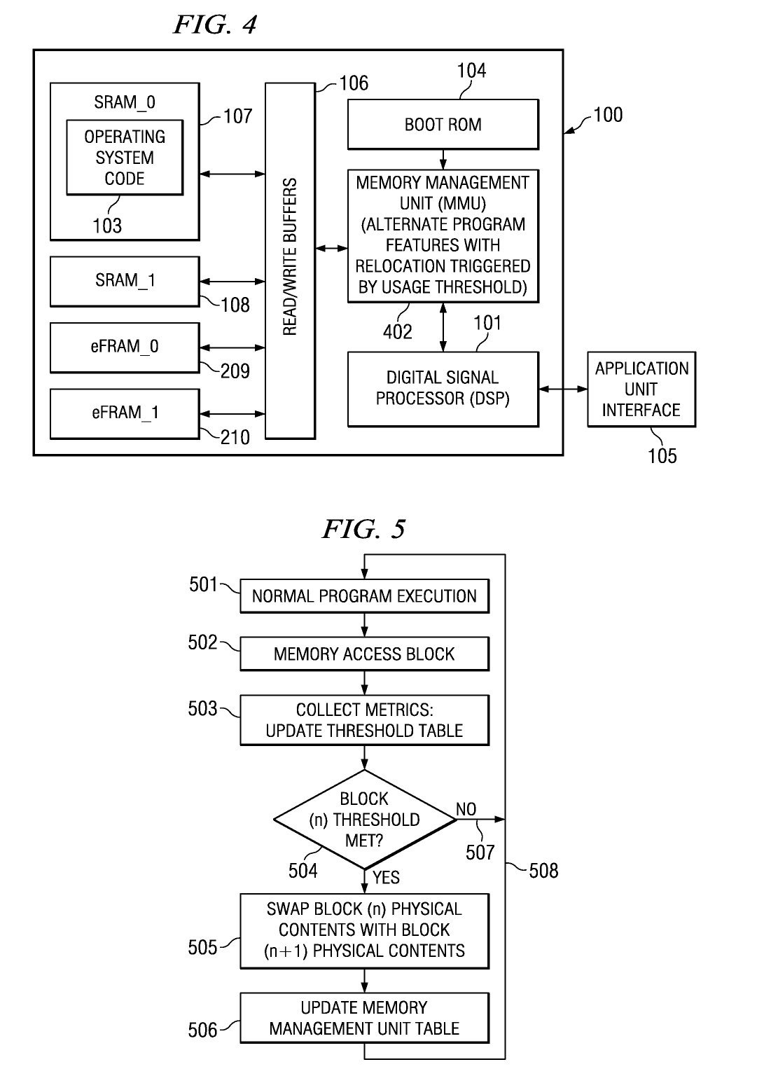

FIG. 4 illustrates the second embodiment of the invention, a less cumbersome method for dynamically relocating memory contents by using added program features in the memory management unit. In FIG. 4 two eFRAM memory units 209 and 210 replace the SRAM units 109 and 110 shown in the conventional system of FIG. 1. Because the eFRAM memory units provide non-volatile memory for the system, the need for the external flash memory 111 of FIG. 1 is eliminated. Additional logic to accumulate memory access metrics, move physical memory contents and to reprogram the virtual address table are now included in the MMU. Instead of creating a memory access vs. cell location profile for an application before hand, the MMU 402 in this method contains a programmable mechanism that triggers a relocation action or event once a threshold has been met. This trigger then causes the MMU hardware to physically move the memory contents to be protected to another block of memory cells and initiates an update to the corresponding virtual address pointers. A pre-determined algorithm is used to calculate which memory block is re-allocated to the recently vacated memory block.

The steps in the second method are illustrated in the flow diagram of FIG. 5. The steps of this method are as follows:

501: the normal program code executed refers to unaltered system code being executed unaffected by any dynamic code relocation processes.

502: a memory access (read or write) occurs on a given block of memory which is designated as block n.

503: the MMU collects metrics information and forms or updates a table listing the number of accesses occurring at each accessed location over a prescribed period of time. After each access, this table is updated in step 503.

504: this query step makes the determination whether block n meets/exceeds the established threshold or not. Two outcomes are possible.

Outcome 1: If the query result is Yes the procedure for swapping the contents of block n with the contents of block (n+1) is initiated in step 505.

505: the corrective action called for is: (a) making a copy of the memory block (n) data to be relocated and placing it in a temporary location; (b) making a copy of memory location (n+1) and writing its contents into memory location (n); (c) writing the copy of the former content of memory location (n) and writing it into location (n+1).

506: upon completing the swap of memory contents the MMU address table is updated.

Outcome 2: for each query completed in step 504, a No result activates loop 507 to proceed with program execution in step 501.

Similarly, upon completing the swap of memory contents in step 506 triggered by a Yes result in the query step, loop 508 is activated to proceed with normal program execution in step 501.

As a result in the second embodiment of the invention, the augmented MMU operation acts to replace any effected code block with the contents of a less frequently accessed code block and reprograms the physical addresses in the MMU table. The once heavily-used memory locality now has contents that are not heavily accessed. The once infrequently accessed physical memory block now contains more highly accessed contents. In this second method as well, higher-level algorithms and code can then operate transparently without recognizing the corrective action and the relocation of the code and can operate normally. By moving the physical location of the effected code the underlying memory cells can then be re-used by routines with less aggressive access profiles.

What is claimed is:

1. A method for controlling repetitive accesses to memory block locations subject to degradation due to aging comprising the steps of:
detecting occurrence of individual read/write cycles;
counting memory accesses per block of memory;
comparing number of memory accesses per memory block with predetermined allowable number threshold;
if number threshold target is exceeded for a specific memory block location, then target code in said memory block for displacement to another location by:
first reading code stored in target memory block, and
second, writing said code to a replacement memory block.

2. The method of claim 1, further comprising the step of:
updating a memory controller table with a new location in a virtual memory block for displaced code.

3. The method of claim 1 wherein
locating a block of less frequently accessed code and storing as a replacement to original code in a memory block exceeding threshold.

4. A method for controlling repetitive accesses to memory block locations subject to degradation due to aging comprising the steps of:
counting memory accesses per block of memory;
comparing a number of memory accesses per memory block with a predetermined allowable number threshold; and
swapping contents of a memory block with contents of a next memory block if a threshold is exceeded.

5. The method of claim 4, further comprising the step of:
updating a memory controller table with new location in a virtual memory block for displaced code.
